(19) United States
(12) Patent Application Publication
(10) Pub. No.: US 2009/0268183 A1
(43) Pub. Date: Oct. 29, 2009

(54) CONDUCTIVE PATTERN FORMING APPARATUS

(75) Inventors: Yuichiro SANO, Mito (JP); Toru MIYASAKA, Hitachinaka (JP); Shigeo NAKAMURA, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/431,021

(22) Filed: Apr. 28, 2009

(30) Foreign Application Priority Data
Apr. 28, 2008 (JP) 2008-116577

(51) Int. Cl. G03B 27/42

(52) U.S. Cl. 355/53

(57) ABSTRACT

Apparatus for forming a conductive pattern capable of stably forming a wiring pattern of a desired thickness by providing at least one thickness detection means for detecting the thickness of a formed pattern and capable of adjusting at least one of parameters such as a developing bias voltage or a concentration of a developer that contributes to the thickness of the pattern based on the information obtained from the thickness detection means.

### CLAIM OF PRIORITY

The present application claims priority from Japanese Patent Application No. 2008-116577 filed on Apr. 28, 2008, the content of which is hereby incorporated by reference into this application.

### BACKGROUND OF THE INVENTION

1. Field of the Invention

The present invention concerns a pattern forming apparatus for patterning aimed particles at a desired position by an electrostatic force.

2. Description of the Related Art

As a substitute technique for existent photolithographic systems having an expensive mask and multi-steps, attention has been attracted to a method of forming a conductive pattern by a printing process of simple steps such as screen printing, dispenser printing, inkjet printing, electrophotographic printing, etc. In each of the processes patterning is performed by utilizing a conductive particle dispersion solution formed by dispersing conductive particles in a solvent or a toner formed by internally adding conductive particles in a resin and by means of indirect coating using a print plate or a screen, direct coating by nozzle scanning, or electrostatic adsorption. Then, the pattern is heated and baked to fuse fine particles to each other thereby obtaining electrically conductive wirings.

Among the various types of the printing processes described above, electrophotographic systems of forming a desired conductive pattern on an insulation substrate by utilizing an electrostatic force have many advantages when compared with other processes since the systems can cope with mass production or patter formation of a large area, as well as the conductive pattern can be changed easily which is advantageous for the production of a wide variety of products in small quantities.

Further, among the electrophotographic systems, a liquid developing system of using a conductive particle dispersion solution formed by dispersing conductive particles in a solvent as a developer is an advantageous system for the improvement of resolution and lowering of the baking temperature when the conductive particles are made electrically conductive by fusion since the system can prevent scattering of fine particles by dispersion of the particles in a liquid, as well as can handle conductive particles of smaller particle diameter (JP-A No. 2006-278801).

Existent electrophotographic systems have been intended to be applied mainly for forming visible image patterns such as texts, illustrations, and photographs. In this case, what is desired for the obtained pattern is that an image pattern arranged at a desired position and having an image density capable of attaining desired color formation is formed. Accordingly, in a case of obtaining identical images continuously, means for stably reproducing visible images at a desired image density is necessary. The image density is determined by the amount of a colorant referred to as a toner fixed on an aimed paper surface.

Accordingly, it is necessary that a desired amount of the toner can be supplied stably. For example, JP-A No. 4-93965 discloses a method of changing the developing bias voltage in the course of detecting the thickness of a toner layer formed and a developing roll that develops the toner based on the detected information, and adjusting the amount of the toner to be supplied, thereby forming a visible image having an amount of toner that can attain a desired image density. However, this is a method of controlling only the amount of the supplied toner but not a method of detecting the amount of an actually formed pattern and controlling the same.

In the formation of the conductive pattern according to the electrophotographic system of the invention, it is intended to form not an image but a wiring for conducting electricity. The purpose of forming the electric pattern is identical with that of forming the image in that a pattern is formed at a desired position. However, since formation of a wiring for conducting electricity is required for the obtained pattern, thickness is an important parameter for the formed pattern. This is because the thickness of the wiring contributes much to the performance of the wiring such as resistance and maximum amount of current.

Accordingly, with respect to the thickness of the obtained wiring pattern, control intended for the pattern thickness at a higher accuracy is necessary compared with a case of the electrophotographic apparatus for forming a visible image which is only required to form an aimed color at a certain density or higher. Further, it is necessary that the pattern can be formed stably with no aging change even when external circumstance, etc. are changed. Furthermore, for the thickness of the wiring pattern, a desired thickness is demanded depending on the purpose of using the formed wiring pattern. Accordingly, it is necessary that the thickness of the pattern can be changed optionally in accordance with the purpose.

The present invention has been achieved in order to solve the foregoing problems and it intends to provide a conductive pattern forming apparatus capable of stably forming a conductive pattern at a stable thickness in the electrophotographic formation of the conductive pattern and having a function capable of adjusting the thickness to a desired value in accordance with the purpose.

### SUMMARY OF THE INVENTION

For attaining the purpose, the present invention provides a conductive pattern forming apparatus having thickness detection means for detecting the thickness of a formed pattern, and having a function capable of adjusting at least one of parameters that contribute to the thickness of the pattern based on the information obtained by the thickness detection means.

According to the invention, not only the pattern of a desired thickness can be formed conforming to a target of manufacture but also a wiring pattern of the desired thickness can be stably formed continuously with no dependence on the external circumstance or the like.

### BRIEF DESCRIPTION OF THE DRAWINGS

FIG. 1 is a schematic view for a method of forming a conductive pattern by an electrophotographic system according to the invention;

FIG. 2 is a schematic view of a conductive particle dispersion solution in the invention;

FIG. 3 is a schematic view of a conductive particle having an ionic organic molecule of low molecular weight; and

FIG. 4 is a schematic view for explaining various types of pattern thickness adjusting means and the constitution thereof in the invention.

### DETAILED DESCRIPTION OF THE PREFERRED EMBODIMENTS

### [Structure of the Apparatus]

A method of forming a conductive pattern by an electrophotographic system according to the invention is to be described with reference to the drawings.

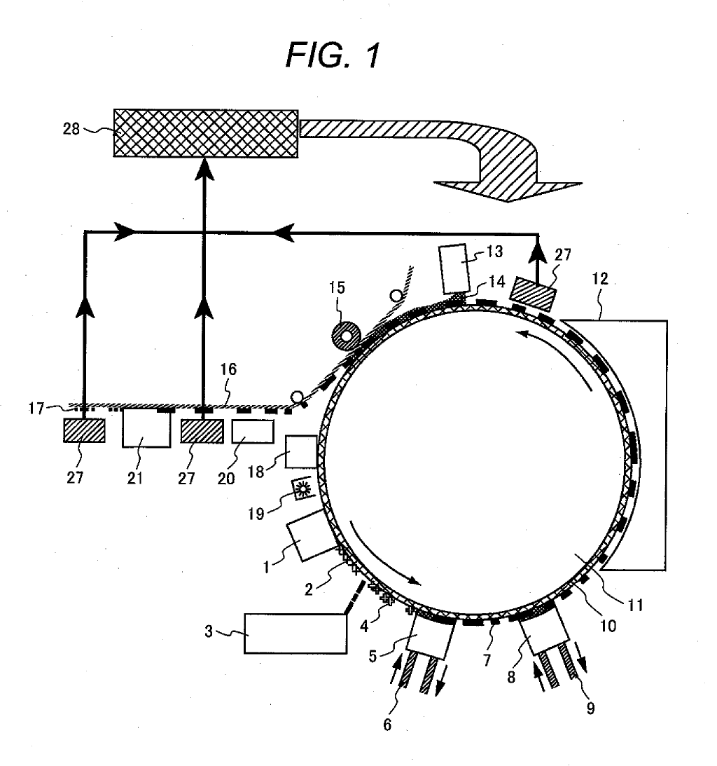

FIG. 1 schematically shows an apparatus applied with the method of forming a conductive pattern by electrophotography in one embodiment of the invention. The apparatus mainly includes a charging device 1, an exposure device 3, a developing device 5 and conductive particle dispersion solution 6, a cleaning device 8 and cleaning solution 9, photoreceptor 11 having a dielectric thin film 10, a solvent removing device 12, a transfer solution coating device 13 and transfer solution 14, an electrostatic transfer device 15, a target substrate 16, a residual conductive particle cleaning means 18, a residual latent image erasing means 19, a residual transfer solution drying device 20, a baking means 21, a thickness detection means 27, and a thickness information control means 28.

In this embodiment, a drum- or belt-shaped photoreceptor 11 having a photosensitive dielectric thin film 10 disposed on the surface thereof is used as a device for forming an electrostatic latent image 2.

### [Control Method of Pattern Thickness]

In the apparatus, the dielectric thin film 10 is charged uniformly at the surface thereof by the charging device 1 (corotron charger, photoreceptor (roller) contact charger, or brush contact charger) disposed at the periphery of the dielectric thin film 10. The amount of charges to be applied is variable by sending a signal from the thickness information control means 28 in accordance with the information for the pattern thickness and the information for the aimed pattern thickness.

A desired pattern thickness can be obtained, for example, by increasing the amount of initial static charges to be applied when it is intended to increase the pattern thickness, or by decreasing the amount of initial static charges when it is intended to decrease the pattern thickness.

Alternatively, it may be adapted such that the amount of the initial static charges applied to the surface of the dielectric thin film 10 can be increased or decreased by setting the charging device 1 so as to recede from or approach to the surface of the dielectric thin film 10 in accordance with the information from the thickness information control means 28, thereby capable of adjusting the increase or decrease of the thickness of the pattern to be formed. The static charges applied in this case maybe either positive charges or negative charges.

The apparatus has an exposure device 3 for scanning a laser light in accordance with an image signal from an image information processing apparatus such as a personal computer to a static latent image 2 charged uniformly by the charging device 1. The exposure device 3 irradiates a light to an optional portion thereby forming an aimed latent image pattern 4.

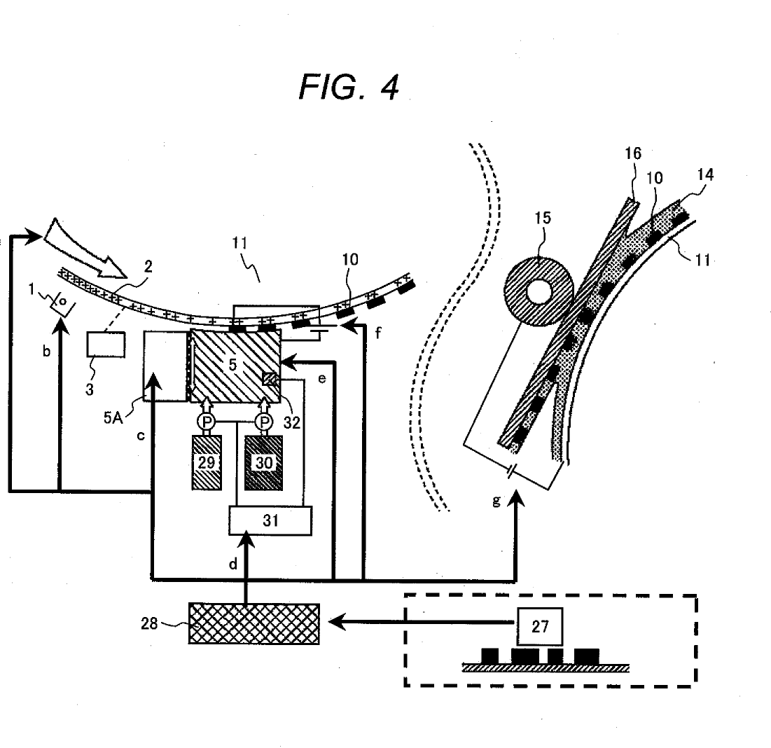

The apparatus has a developing device 5 for developing to form a developed pattern as a conductive pattern precursor 7 by supplying a conductive particle dispersion solution 6 so as to be in contact with the latent image pattern 4 formed on the photoreceptor 11. The developing device 5 is to be described with reference to FIG. 4.

The developing device 5 has a tank (not illustrated) for storing the conductive particle dispersion solution 6 and a supplying means for supplying the conductive particle dispersion solution 6 to the latent image pattern 4 on the dielectric thin film 10. The supplying means includes, for example, a supply roll having a roll (not illustrated) of a width identical with or larger than the width of the photoreceptor 11, in which a liquid film is formed from the conductive particle dispersion solution 6 on the surface of the roll, and the conductive particle dispersion solution 6 is supplied to the vicinity of the photoreceptor 11 and brought into contact therewith by rotating the roll, or a slit type developing device of discharging the conductive particle dispersion solution 6 from the slit-like discharge port for the conductive particle dispersion solution 6 onto the latent image pattern 4 on the dielectric thin film 10.

Alternatively, a method of dipping the dielectric thin film 10 on which the static latent image pattern 5 is formed into a solution that stores the conductive particle dispersion solution 6 may also be used.

Any type of the developing device described above has a liquid storing tank (not illustrated) for storing the conductive particle dispersion solution 6 to be supplied, and a concentration sensor 32 for detecting the concentration of the conductive particle dispersion solution 6 is disposed to the storing tank (FIG. 4).

Further, the apparatus also has a tank 30 for storing the conductive particle dispersion solution 6 at a high concentration or conductive particles 24, and a tank 29 for storing only the non-polar solvent 22 formed by removing a particle ingredient from the conductive particle dispersion solution 6. They are added to the conductive particle dispersion solution 6 by a pump while being controlled by a concentration adjusting device 31 based on the concentration information of the conductive particle dispersion solution 6 in order to keep the concentration of the conductive particle dispersion solution 6 that varies along with the printing process at a constant level in the liquid storing tank.

In addition, the developing device 5 may be adapted such that increase and the decrease of the thickness of the pattern to be formed can be adjusted by increasing or decreasing the concentration of the conductive particle dispersion solution 6 in accordance with the information from the thickness information control means 28.

For example, when it is intended to increase the pattern thickness, a conductive particle dispersion solution 30 at a high concentration or the conductive particle 24 is added to the conductive particle dispersion solution 6 thereby increasing the concentration of the conductive particle dispersion solution 6. On the other hand, when it is intended to decrease the pattern thickness, only the non-polar solvent 22 is added to the conductive particle dispersion solution 6 thereby lowering the concentration of the conductive particle dispersion solution 6.

In this case, any of the tanks is provided with a stirring device for preventing precipitation and for making the concentration uniform over the entire region. As the stirring device, a supersonic wave irradiation device, a stirring device using a stirring blade for mechanically stirring the inside of the liquid, a vibration device for stirring by vibrating the storing tank itself, etc. can be used.

Since the pattern thickness can be adjusted by applying a voltage to a developing region, a voltage application device capable of applying a voltage upon development of the conductive particles 24 for accelerating the development is provided between the supply role for the conductive particle dispersion solution 6 or the slit-shape dispersion supply port of the developing device 5 and the dielectric thin film 10. In this case, the applied voltage is variable in accordance with a signal sent from the thickness information control means 28 based on the information obtained by the pattern thickness detection means 27.

Since the pattern thickness can be adjusted by the gap distance to which the voltage is applied during development, the developing device 5 may be adapted also such that increase or decrease of the thickness of the formed pattern can be adjusted by enabling the developing device 5 by an actuator 5A to approach to or recede from the surface of the dielectric thin film 10 such that the gap distance formed between the surface of the film 10 and the supply roll of the conductive particle dispersion solution 6 or the slit-like dispersion supply port can be changed in accordance with a signal from the thickness information control means 28 based on the information obtained from the pattern thickness detection means 27 .

Alternatively, it may also be adapted such that increase or decrease of the thickness of the formed pattern can be adjusted by fixing the developing device 5 and enabling the surface of the dielectric thin film 10 itself to approach to and recede from the conductive particle dispersion solution supply roll or the slit-like dispersion supply port of the developing device 5.

The method of controlling the gap distance on the side of the dielectric thin film 10 includes, for example, in a case of using a drum-shaped dielectric thin film 10, a method of replacing the thin film with that of different outer diameter. In a case of using the belt-shaped dielectric thin film 10, it includes a method of applying a force at the back of the dielectric thin film 10 in a developing region thereby deforming the surface of the dielectric thin film to the side of the developing device 5.

### [Conductive Particle Dispersion Solution]

The viscosity of the conductive particle dispersion solution 6 changes depending on the temperature. In this case, change of the viscosity of the conductive particle dispersion solution 6 also changes the developing speed of the conductive particles 24, by which the thickness of the formed pattern is also increased or decreased.

Accordingly, it may be adapted also such that increase or decrease of the pattern thickness can be adjusted by increasing or decreasing the temperature of the conductive particle dispersion solution 6 in accordance with the signal from the thickness information control means 28 based on the information obtained from the pattern thickness detection means 27.

Since the pattern thickness changes also depending on the speed of the surface of the dielectric thin film 10 that passes over the developing region, it maybe adapted also such that increase or decrease of the thickness of the formed pattern can be adjusted by increasing or decreasing the driving speed of the dielectric thin film 10 in accordance with a signal from the thickness information control means 28 based on the information obtained from the pattern thickness detection means 27 (arrow a in FIG. 4).

Since the pattern thickness changes also depending on the transfer bias voltage between the electrostatic transfer device 15 and photoreceptor 11, it may be adapted also such that increase or decrease of the thickness of the formed pattern can be adjusted by increasing or decreasing the bias voltage of the electrostatic transfer device 15 in accordance with a signal from the thickness information control means 28 (arrow g in FIG. 4).

### [Combination of Pattern Thickness Control]

Specifically, as shown in FIG. 4, the thickness adjusting means 28 adjusts the thickness of the formed pattern in accordance with the information detected by the pattern thickness detection means 27 by using at least one of adjustment based on the control of the rotational speed of the photoreceptor (a in FIG. 4), adjustment based on the initial amount of charges by the charging device (b in FIG. 4), adjustment based on the control of the distance between the developing device and the photoreceptor (c in FIG. 4), adjustment based on the control of the concentration of the conductive particle dispersion solution (d in FIG. 4), adjustment based on the change of the temperature of the conductive particle dispersion (e in FIG. 4), adjustment based on the developing bias voltage (f in FIG. 4), and adjustment based on the transfer bias voltage (g in FIG. 4).

Means for adjusting the pattern thickness is adapted such that at least one of the means described above can be adjusted. For adjusting the film thickness at a higher accuracy, it is preferred that the thickness of the formed pattern can be adjusted by combining a plurality of means.

### [Conductive Particle Dispersion Solution]

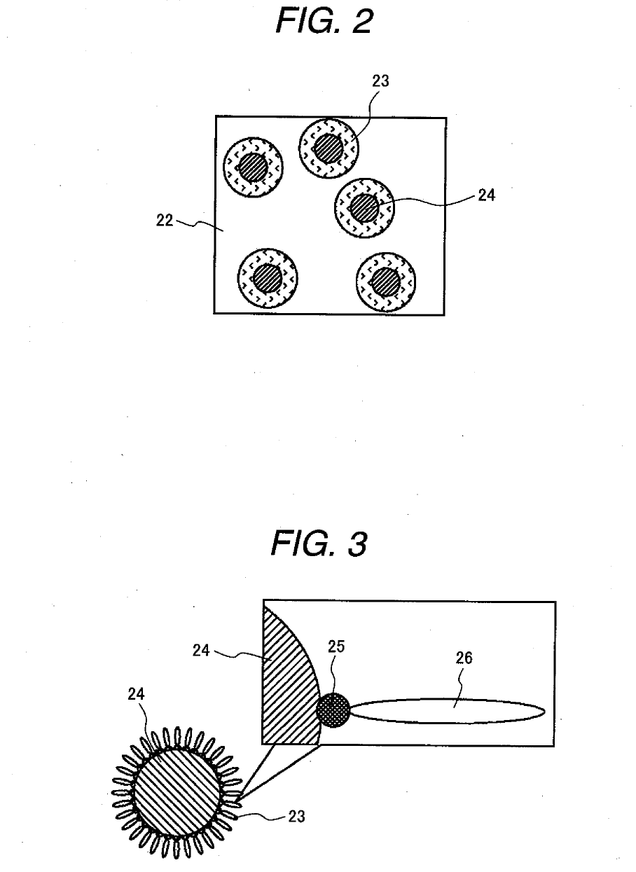

Details for the conductive particle dispersion solution 6 are shown in FIG. 2 and FIG. 3. The conductive particle dispersion solution 6 is formed by dispersing conductive particles 24 each of a particle size of 100 nm or less and having ionic organic molecules 23 adsorbed on the surface thereof in a non-polar solvent 22. 25 is a inorganic ion and 26 is a organic ion.

The ionic organic molecule 23 includes, in the case of polymers, the following polymer resins having a functional group capable of providing an ionic property such as a carboxylic acid group or an amino acid group each alone or in admixture, i.e., homopolymers and copolymers of styrene and substitutes thereof such as polystyrene, poly-p-chlorostyrene, polyvinyl toluene, styrene-p-chlorostyrene copolymer, and styrene-vinyl toluene copolymer; copolymers of styrene and acrylic acid ester such as styrene-methyl acrylate copolymer, styrene-ethyl acrylate copolymer, and styrene-acrylic acid-n-butyl copolymer; copolymer of styrene and methacrylic acid ester such as styrene-methyl methacrylate copolymer, styrene-ethyl methacrylate copolymer, and styrene-methacrylic acid-n-butyl copolymer; styrenic copolymers of styrene and other vinylic monomers such as multi-component copolymer of styrene, acrylate ester, and methacrylate ester, styrene-acrylonitrile copolymer, styrene-vinyl methyl ether copolymer, styrene-butadiene copolymer, styrene-vinyl methyl ketone copolymer, and styrene-maleic acid ester copolymer; methacrylic acid ester resins such as polymethyl methacrylate, and polybutyl methacrylate; acrylic acid ester resins such as polymethyl acrylate, polyethyl acrylate, and polybutyl acrylate; polyester resins, epoxy resins, and cycloolefinic copolymers.

The ionic organic molecule, in the case of low molecular weight compounds includes, for example, inorganic salts of aliphatic carboxylic acids comprising aliphatic carboxylic acid ions 19 derived from the following aliphatic carboxylic acids and inorganic ions 25 derived from Ag, Cu, Au, Pd, Pt, Ni, W, Mo, Cr, etc., the aliphatic carboxylic acids including, for example, dicarboxylic acids such as oxalic acid, malonic acid, succinic acid, adipic acid, glutaric acid, 2,4-diethyl glutaric acid, 2,4-dimethyl glutaric acid, pimeric acid, azelaic acid, sebacic acid, cyclohexane dicarboxylic acid, maleic acid, coumaric acid, and diglycolic acid; fatty acids such as caprylic acid, lauric acid, myristic acid, palmitic acid, stearic acid, arachic acid, behenic acid, linoleic acid, oleic acid, and linolenic acid; hydroxycarboxylic acid such as lactic acid, hydroxypivalic acid, dimethylol propionic acid, citric acid, malic acid, and glycerinic acid.

For making the conductive pattern precursor 7 electroconductive, it is necessary to burn out the organic ingredient (organic ion 26) at the periphery of the conductive particle 24 by heating. The heat energy necessary for baking is lower in the low molecular weight ingredient than in the high molecular weight ingredient. Accordingly, when a resin substrate, for example, made of a polyimide having low heat resistant temperature is used as a target substrate 16 for forming the conductive pattern, it is preferred to use a low molecular weight organic molecule that can be baked at a lower baking temperature.

Further, when the low molecular weight organic molecule is used, the ratio of the residual organic molecule in the conductor pattern 17 that increases the resistivity of the electroconductive pattern is lower compared with the case of using a high molecular weight organic molecule. With the view point described above, the organic molecule ingredient at the periphery of the conductive particle 24 is preferably an organic molecule of low molecular weight.

It is necessary that the grain size of the conductive particle 24 is 100 nm or less so as to improve the resolution of the conductive pattern 17. In a case of fusing the conductive particles 24 thereby making the conductive pattern precursor 7 electroconductive by heating at a temperature of 200° C. or lower, the grain size of the conductive particle 24 is set to 10 nm or less. When a conductive pattern 17 having a line width of 100 nm or less is necessary, the grain size of the conductive particle 24 is set to 5 nm or less.

For the conductive particle 24, an elemental metal such as Ag, Cu, Au, Pd, Pt, Ni, W, Mo, Cr, etc., or oxides of the metals described above or alloys of such metals are used. In a case where an electric conductor is necessary, Ag or Cu of low volumic resistivity is used. The plurality of metals, oxides thereof, or the alloys thereof can be used in admixture.

For the non-polar solvent 22, aliphatic hydrocarbon solvents are used. The aliphatic hydrocarbon solvent includes iso-paraffinic or petroleum naphtha type, Isoper (Exxon Mobil Chemical Co.), IP solvent (Idemitsu Kosan Co.), Sortol (Phillips Petroleum Co.), and other hydrocarbons.

### [Conductive Pattern Forming]

The conductive pattern forming apparatus by the electrophotographic system in this embodiment has an electrostatic transfer device 15 for transferring the conductive pattern precursor 7 developed on the dielectric thin film 10 to a target substrate 16. The electrostatic transfer device 15 adopts an electrostatic transfer system of applying a voltage from the back surface by way of a transferred layer of the target substrate 16 and transferring the conductive pattern precursor 7 developed on the dielectric thin film 10 by static electricity to the target substrate 16.

For transferring the conductive pattern precursor 7 developed on the dielectric thin film 10 in a state being kept as a pattern, the non-polar solvent 22 remaining pattern-wise is once removed after development or cleaning, for example, by the heat from a solvent removing device 12 and the pattern is transferred after coating a transfer solution 14 again as a solvent necessary for transfer by a transfer solution coating device 13.

This embodiment adopts an electrostatic transfer system of transferring the conductive pattern precursor 7 on the target substrate 16 by an electrostatic force. By applying a voltage from the back surface of the target substrate 16 for transfer, the pattern on the dielectric thin film 10 is electrostatically attracted and transferred to the target substrate 16.

In this case, when the applied voltage is increased or decreased in the electrostatic transfer device 15, the amount of the conductive pattern precursor 7 transferred to the target substrate 16 is changed. That is, the thickness of the conductive pattern precursor 7 after transfer is also changed.

Accordingly, the thickness of the pattern to be transferred may also be adjusted by changing the voltage applied during transfer in accordance with a signal from the thickness information control means 28 based on the information obtained by the pattern thickness detection means 27. However, while the pattern thickness adjustment in the transfer is advantageous for decreasing the pattern thickness, it is difficult to increase the pattern thickness. Accordingly, an aimed value for the thickness of the formed pattern may be set somewhat higher and, when a pattern formed previously at a somewhat increased thickness by the plurality of pattern thickness adjusting means is transferred by the electrostatic transfer device 15, the application voltage is adjusted so as to reduce the excessive thickness thereby forming a pattern having a desired thickness on the target substrate 16.

Transfer to a target is performed in this embodiment by a method of directly transferring a conductive pattern on a target substrate or a method of temporarily holding a conductive pattern precursor 7 on a conductive holding substrate (intermediate transfer body) and then transferring the transferred pattern further to a target substrate 16.

In a case of the method of direct transfer to the aimed target substrate 16, it is preferred that the target substrate 16 has a resistance to heating at 100 to 250° C. and is in a sheet-like member having a thickness of 1 mm or less for coping with the application of the transfer bias voltage from the back surface of the target substrate 16. Examples of the material forming the target substrate 16 include, for example, a resin sheet made of polyimide or a ceramic green sheet.

The conductive pattern forming apparatus in this embodiment has a baking device 21 for fixing the conductive pattern precursor 7 transferred to the substrate 16 to the target substrate 16 and fusing the conductive particles 24 to each other thereby making them electroconductive to form a conductive pattern 17. The baking device 21 not only fuses the conductive particles 24 to each other but also bakes the dispersion layer applied to the surface of the conductive particles 24.

In this case, the apparatus may also have a mechanism capable of pressurizing the conductive pattern precursor 7 to the target substrate 16 at the same time with heating. The heating temperature is preferably 300° C. or lower for sufficiently fusing the conductive particles 24, baking the ionic organic molecule 23, and preventing deformation or denaturation of the target substrate 16. Exhaust device for exhausting the baked organic ingredient may also be provided.

In the conductive pattern forming apparatus of this embodiment, the dielectric thin film 10 may also be adapted such that a latent image is formed thereon and the conductive pattern precursor 7 is developed again after transferring the conductive pattern. For the shape, a belt-like or drum-like shape is preferred. Further, the apparatus also has a residual latent image erasing means 19 for erasing residual static latent images on the dielectric thin film 10 and a residual conductive particle cleaning means 18 for removing and recovering residual conductive particle 24 after transfer.

The residual conductive particle cleaning means 18 includes a method of scraping off the particles by the contact of a blade with the dielectric thin film 10 or a method of flushing away the particles by a solvent. Further, the removed and recovered conductive particles 24 may be recycled by being returned to the developing device 5 and dispersed again in the conductive particle dispersion solvent 6.

### [Pattern Thickness Detection]

As shown in FIG. 4, the conductive pattern forming apparatus in this embodiment has a pattern thickness detection means 27 capable of detecting the thickness of the formed pattern. Further, it also has the thickness information control means 28 for controlling the output of a signal for adjusting to a desired pattern thickness by various types of the pattern thickness adjusting means described above based on the information obtained from the pattern thickness detection means 27.

The target for the pattern thickness detection includes a developed pattern formed on the dielectric thin film 10 after development, a transferred pattern formed by transferring the developed pattern to the target substrate 16, and a conductor pattern 17 after the transferred pattern on the target substrate 16 is made electroconductive by way of the baking means 21.

The pattern thickness detection means 27 for the developed pattern as a target is disposed at a position for detecting the surface of the dielectric thin film 10 between the developing device 5 and the transfer device 15. In this case, since the non-polar solvent 22 remains on the pattern just after the development, the developed pattern thickness detection means 27 is disposed preferably at a position capable of detection in a state where the solvent has been removed from the pattern by way of the solvent removing device 12.

The pattern thickness detection means 27 for the transfer pattern as a target is disposed at a position for detecting the surface of the target substrate 16 between the transfer device 15 and the baking device 21. In this case, since the transfer solution 14 remains in the transferred pattern on the target substrate 16 just after the transfer, the pattern thickness detection means 27 is disposed preferably at a position where the transfer solution 14 has been removed from the pattern by way of the residual transfer solution drying device 20. The pattern thickness detection means 27 for the conductor pattern 17 as a target is disposed after the baking means 21.

The pattern thickness is detected for at least one of the three patterns described above as the target. However, once a failed pattern should happen to be formed, this cannot be restored for the transferred pattern and the baked pattern, whereas the pattern thickness can be adjusted in the case of the developed pattern by the subsequent transfer device 15. Accordingly, it is preferred to provide at least the pattern detection means for the developed pattern as the target.

The thickness detection method in the pattern thickness detection means 27 includes a contact type or non-contact type film thickness sensor. However, when the developed pattern or the transferred pattern before baking in which the particles are not yet made electroconductive is measured by the film thickness sensor of the former contact type, the pattern may possibly be destroyed.

Accordingly, for the developed pattern or the transferred pattern, the non-contact type film thickness sensor is used preferably. As other thickness detection method, a method of determining the thickness of the formed pattern based on the measurement for the area of the formed pattern and the amount of decrease of the particles in the conductive particle dispersion solution may also be used.

Further, it may also be used a method of previously measuring aimed coloration densities at various thicknesses in the conductive particles 24 by reflection of light or the like, prepare a data base based on the result, and deciding the thickness based on the coloration density by measurement on real time with reference to the data base. In this case, a dye may be previously added to the conductive particle dispersion solution 6 to accelerate the coloration of the pattern thereby improving the detection sensitivity for the coloration density and improving the accuracy for the measurement of the film thickness.

In this case, it is necessary to add such a dye ingredient as giving no undesired effects on the accuracy of the obtained conductor pattern 17. Further, it is preferred that the ingredient has such a low melting point as it is burnt off upon baking of the conductor pattern 17.

For the pattern used as a target for the detection of the thickness, a method of measuring an actually used pattern itself may be adopted and, in addition, a developed pattern which is formed exclusively for the purpose of detecting the pattern thickness but not transferred to the actually used target substrate maybe prepared at the end of the dielectric thin film 10 and the film thickness may be adjusted based on the result of the measurement thereof as a representative value.

The conductive pattern 17 formed by the conductive particle dispersion solution 6 of this embodiment can be used as wirings for substrates such as for personal computers, large-scaled electronic computers, notebook-sized personal computers, pen-input personal computers, notebook-sized word processors, cellular phones, portable cards, wrist watches, cameras, electric shavers, codeless telephones, facsimile units, video units, video cameras, electronic notepads, portable calculators, electronic notepads having communication function, portable copying machines, liquid crystal televisions, electromotive tools, vacuum cleaners, game equipment having a function of virtual reality, toys, electromotive bicycles, walking aids for healthcare, wheel chairs for healthcare, movable beds for healthcare, escalators, elevators, forklifts, golf carts, emergency power source, road conditioners, and power storage systems, or wirings for substrate such as for driving circuits of flat screen televisions such as liquid crystal televisions, plasma televisions, and organic EL, and flexible displays such as electronic paper. Further, this can also be used for domestic application uses, as well as military and space application uses.

What is claimed is:

1. A pattern forming apparatus for forming a pattern of an electrostatic latent images formed on a dielectric thin film into a pattern by electrostatic adsorption of charged particles, including pattern thickness detection means for detecting the thickness of a formed pattern on a real time, and a plurality of pattern thickness adjusting means capable of increasing or decreasing the thickness of the formed pattern, wherein a pattern having a desired thickness is formed stably by adjusting at least one of the plurality of pattern thickness adjusting means based on information detected by the pattern thickness detection means.

2. A conductive pattern forming apparatus according to claim 1, wherein the pattern as a target of detection by the pattern thickness detection means includes at least one of a developed pattern present on the dielectric thin film between a developing device and a transfer device, a transferred pattern present on a target substrate between the transfer device and a baking device, or a conductor pattern present on an aimed target substrate after the baking means.

3. A conductive pattern forming apparatus according to claim 1, wherein the thickness adjusting means for the formed pattern based on the information detected by the pattern thickness detection means uses at least one of adjustment based on an initial charged amount by a charging device, adjustment based on the control for the rotational speed of a photoreceptor, adjustment based on the control for the distance between the developing device and the photoreceptor, adjustment based on the control for the concentration of a conductive particle dispersion solution, adjustment based on the change of temperature of the conductive dispersion, and adjustment based on the developing bias voltage, and adjustment based on the transfer bias voltage.

4. A conductive pattern forming apparatus according to claim 1, wherein the conductive particle dispersion solution is a solution formed by dispersing, into a liquid, electroconductive particles that are made electroconductive by heating or pressurization.

5. A conductive pattern forming apparatus according to claim 1, wherein the particle size of the conductive particles to be dispersed in the conductive particle dispersion solution is 100 nm or less.

6. A conductive pattern forming apparatus according to claim 1, wherein the conductive particle has ionic organic molecules on the surface thereof and is dispersed in a non-polar solvent.

7. A conductive pattern forming apparatus according to claim 1, wherein the pattern thickness detection means is means for measuring a film thickness in a non-contact manner by a laser or a supersonic wave.

8. A conductive pattern forming apparatus according to claim 1, wherein the pattern thickness detection means is means for measuring the area of a pattern, which is adapted to calculate a film thickness based on the weight of the conductive particles decreased by the patterning.

9. A conductive pattern forming apparatus according to claim 1, wherein the difference in the state of color formation depending on the thickness of the pattern is previously prepared as a data base, and the pattern thickness detection means determines the thickness indirectly based on the result detected by a non-contact color density sensor with reference to the prepared data base.

10. A conductive pattern forming apparatus according to claim 1, wherein the sensitivity for the detection of the thickness of the pattern thickness detection means is also improved by adding a dye ingredient into the pattern thereby improving the sensitivity for color formation.

11. A conductive pattern forming apparatus according to claim 2, wherein the thickness adjusting means for the formed pattern based on the information detected by the pattern thickness detection means uses at least one of adjustment based on an initial charged amount by a charging device, adjustment based on the control for the rotational speed of a photoreceptor, adjustment based on the control for the distance between the developing device and the photoreceptor, adjustment based on the control for the concentration of a conductive particle dispersion solution, adjustment based on the change of temperature of the conductive dispersion, and adjustment based on the developing bias voltage, and adjustment based on the transfer bias voltage.
